(19) United States
(12) Patent Application Publication
(10) Pub. No.: US 2013/0293341 A1
(43) Pub. Date: Nov. 7, 2013

(54) ELECTRICAL FUSE

(71) Applicant: Axel Krause, Nesslau (CH)

(72) Inventor: Axel Krause, Nesslau (CH)

(73) Assignee: BRUSA ELEKTRONIK AG, Sennwald (CH)

(21) Appl. No.: 13/816,460

(22) PCT Filed: Aug. 16, 2011
(86) PCT No.: PCT/IB11/53620

§ 371 Date: Feb. 13, 2013

Related U.S. Application Data
(60) Provisional application No. 61/392,919, filed on Oct. 13, 2010.

(30) Foreign Application Priority Data
Aug. 23, 2010 (EP) 10173730

(51) Int. Cl. H01H 85/02

(52) U.S. Cl. CPC H01H 85/0241
USPC 337/187

(57) ABSTRACT

The invention relates to an electrical fuse (1) having a fuse housing (2) and at least two electrical contacts (3) accessible from outside of the fuse housing (2), which are 5 connected to each other inside the fuse housing (2) via a fusible conductor (4). To provide better thermal dissipation of the heat that is generated, a wall of the fuse housing (2) externally forms a fixing surface (12) for attaching the fuse (1).

This application is a 35 U.S.C. 371 national-phase entry of PCT International application no. PCT/IB2011/053620 filed on Aug. 16, 2011 and also claims benefit of priority to prior European application no. EP10173730 filed on Aug. 23, 2010, and also claims priority as a non-provisional of U.S. provisional application Ser. No. 61/392,919 filed on Oct. 13, 2010, and both European application no. EP10173730 and U.S. provisional application Ser. No. 61/392,919, as well as parent PCT International application no. PCT/IB2011/053620, are all incorporated herein by reference in their entireties for all intents and purposes, as if identically set forth in full herein.

The invention relates to an electrical fuse having a fuse housing and at least two electrical contacts, accessible from outside the fuse housing, which are connected together inside the fuse housing via fusible conductors.

The invention also relates to a fuse arrangement with at least one electrical fuse and a holder. This means that one or more fuses (fusible conductors) can be arranged on the same holder.

In power electronics there is a requirement to provide appropriately dimensioned electrical fuses. A problem that occurs in relation to this is the heat arising in the fuse, which is conditioned primarily by the cross-section of the fusible conductor. The fusible conductor is normally embedded in quartz sand, in order to prevent dangerous arcs if the fuse should burn out. To dissipate the heat arising in the fusible conductor in normal operation and retained in the quartz sand various solutions are proposed in the prior art.

One relevant document is U.S. Pat. No. 3,793,603 A, which describes an electrical fuse with a liquid-cooled housing. Small channels with circular cross-section extend in a helical shape through the housing, which is filled with quartz sand. The fusible conductor itself is embedded in the quartz sand and folded in a uniformly distributed manner over the volume. At the folding points the fusible conductor comes close to the housing wall or can come into contact with it there. The disadvantage of such a fuse consists in the fact that a considerable part of the heat is lost to the quartz sand and is retained by it. Replacement of the fuse is only ever possible as a whole unit, i.e. together with the housing containing the channels. This results in expensive fuses.

WO 02/086930A1 discloses a fuse arrangement in which cooling coils cool the outer contact plates, between which the fuses are arranged. Every time the fuse is replaced the cooling coils are in the way and/or must be completely removed. This causes costly maintenance and increased production costs. Besides, the cooling coils only cool the fuses indirectly via the contact plates, which means that efficient heat dissipation is impossible.

U.S. Pat. No. 3,671,911A discloses a modular system consisting of fuses and coolant liquid channels that are inserted or screwed in between the fuses. As in the previously cited document, in this case only the outer contacts are cooled. The space requirement of such fuses is extremely disadvantageous, on account of the structure and the connection elements.

DE 1948030A discloses a safety fuse cartridge with a sandwich structure. Cooling plates are provided between the fuse elements, which consist of coolant coils. In order to be able to replace a defective or burnt out fuse, the entire sandwich structure must be disassembled, which means enormous maintenance costs. If the entire unit needs to be replaced, high manufacturing costs must be expected. Since cooling plates are provided on both sides of the fuse, the space requirements increase drastically.

GB 1,133,817A discloses an electrical fuse which is arranged in a compound structure, wherein a channel filled with coolant is provided between individual fuses. As in the previously cited documents, in this case also the entire fuse must be disassembled, if a fuse burns out, if this is even possible at all.

U.S. Pat. No. 4,041,434A discloses a fuse in which a cooling channel is guided through the centre of the fuse housing, wherein the fusible conductors are embedded in quartz sand and extend in the immediate surroundings of the flow channel. In this fuse the production costs are also enormous, because a flow channel must be provided for every fuse.

Document CH 547551A discloses a liquid-cooled fuse. The liquid channels are located externally abutting on the contacts and only cool the inside of the fuse indirectly. Again the entire fuse including the channels must be replaced, at great expense.

U.S. Pat. No. 3,713,065 discloses an electrical fuse through which liquid flows throughout the whole device. This requires a very complex and sealed construction and is not suitable for most applications in power electronics.

EP 0321 771 B1 discloses a miniature fuse, for which no efficient heat dissipation measures are taken. For power electronics such fuses are only of limited suitability.

DE 20200601 7651 U1 discloses a fuse holder with a cooling vane. To dissipate heat, heat dissipation vanes are provided, which are embedded in a casting compound.

In the context of a current-limiting fuse CA 2,071,617A1 discloses a means of cooling by thermally conductive material, which is wrapped around the cylindrical fuse.

U.S. Pat. No. 3,810,063A discloses a fuse including heat removing means. The fuse structure comprises within a housing a plurality of flat conductors of fusible material. The flat conductors are embedded in a pulverulent arc quenching material. A heat exchanger comprises fins and valleys between the fins. The heat exchanger may be secured to the top surface of the fuse cover by a bolt or by a high temperature epoxy resin cement. The flat surfaces of the fusible conductors are perpendicular to the top surface of the fuse cover. The disadvantage of such a fuse consists in the fact that a considerable part of the heat is lost to the arc quenching material and is retained by it.

U.S. Pat. No. 3,611,107A discloses a converter bus structure and stud-mounted diodes and fuses therefor. The fuses have cylindrical shape and are threaded into AC buses. The buses may have a fin configuration to promote air cooling of the bus and may also have channels for conducting a cooling fluid. The fins and channels are specifically provided for cooling the bus, however, a concomitant cooling of the fuse is not achievable by such a design.

EP062621A2 discloses a fuse with a cylindrically shaped housing made of two pieces. Two fusible conductors extend between the end walls of the cylinder. Due to the specific design a considerable part of the heat is retained by the arc quenching material. An active cooling is not provided.

US2003/0221813A1 discloses a heat sink assembly for cooling a device, e.g. semiconductor, using circulating fluid. The heat sink assembly has a very complicated inner structure of channels and is therefore a high-price product. The document gives no information with respect to fuses.

Danfoss has developed directly moulded electronic modules (direct moulding), in which all electronic components are moulded (“cast”) together with the housing in one process. This allows a simpler production and also good thermal coupling. There is a one-stage method and a two-stage method. Fibre-composite plastics are used, among others, to increase the stability in components of this type. In connection with fuses this relatively new method “direct moulding” is not known and therefore no advantages are indicated in connection with fuses.

The object of the invention is to overcome the problems associated with the prior art and to provide an electrical fuse in which the internally produced heat can be efficiently and directly dissipated externally. At the same time, the space requirements and the production costs are to remain low and the replacement capability of the fuse should be able to be effected without great expense.

This objective is achieved with an electrical fuse of the type described above, by the fact that a wall of the fuse housing externally forms a flat fixing surface for fixing the fuse to a cooled surface.

This ensures that the heat passed over the relevant wall and the fixing surface can be dissipated directly to that component to which the fuse is to be attached during its installation according to specification.

The fixing surface therefore has two functions according to the invention, namely fixing and heat transmission. The idea behind the invention is with the mechanical connection of the fuse to a holder, to also create at the same time an efficient thermal connection, so that the fuse itself is cooled via its own housing. The fuses according to the invention can thus be designed to be very flat and sparing in the use of material, and therefore able to be screwed onto a cooling platform like other standard electronic components for power electronics. The fuse is cooled in the same way over its housing or the housing wall.

In devices which contain e.g. power electronics, coolable fuses can be deployed in a modular construction with the ability to be cooled more efficiently and moreover, at lower cost. In addition, the construction according to the invention is highly space-efficient. The fuse does not hang or float in space like conventional high-current fuses. The high power and packaging density and the outstanding vibration characteristics and robustness, due to the direct coupling via a fixing surface, also facilitate reliable application in the automotive field.

If required the fuses according to the invention can also be stacked, wherein both the underside as well as the top are designed as fixing surfaces. In accordance with natural laws it is then the fuse that is furthest away from the cooled surface which is cooled the least. If this is taken into account during the design however, then compact small-platform structures can be created.

In one embodiment the fuse housing has a flat construction, wherein the dimensions of a housing wall, which externally forms the flat fixing surface, is substantially larger, preferably more than twice as large, than the dimensions of the side walls of the fuse housing bounding this wall.

If required the fuses according to the invention can also be stacked, wherein both the underside as well as the top are designed as fixing surfaces. In accordance with natural laws it is then the fuse that is furthest away from the cooled surface which is cooled the least. If this is taken into account during the design however, then compact small-platform structures can be created. Also, structures can be realised in this way that can be cooled both from the underside and also through the top, by means of a cooling surface on each face of a cooled component.

In one embodiment the fusible conductor extends essentially in a plane, which is parallel to the fixing surface or fixing surfaces. In its position the fusible conductor is surrounded on all sides by spark quenching material (e.g. quartz sand or similar).

By means of these measures a flat, space-saving construction with optimal thermal coupling and dissipation is achieved. The quartz sand is incorporated into the production, where appropriate by an innovative method, in which during the assembly of the fuse housing the quartz sand is introduced in the form of a “pre-baked” compact form together with the fusible conductor. The pre-baking can be achieved by the sand being temporarily held together with the fusible conductor, by electrostatic means, by means of mildly volatile wetting substances or by means of water, in the same shape as later forms a cavity in the final form of the fuse in which on one side the fusible conductor lies and on the other side the sand is present, which is by then in granular form again.

As is known per se, the quartz sand effects an interruption of the spark, both by cooling the spark and also an electrically insulating action due to its physical structure. In addition however, due to its granular packing the sand creates a sufficiently large cavity to provide room for a sudden pressure increase if the fusible conductor burns out.

This principle is preferably additionally exploited in the fuses according to the invention, wherein they are not restricted to quartz sand alone. All known and future new substances, which conform to these effects of the quartz sand cited above, are applicable in the context of the invention. These can also include fire extinguishing powders, gel-based substances or the like.

In one embodiment the fusible conductor extends internally along the wall of the fuse housing forming the fixing surface and is fixed thereto at least at some points.

This measure guarantees that the fusible conductor extending in the immediate proximity of the wall and fixed thereto emits its heat more strongly to this wall, via which the heat can then be introduced directly to the outside via the fixing surface into the component to which the fuse is attached.

In one embodiment the fusible conductor is arranged opposite the wall in an undulating manner and fixed to the fuse housing in the valleys of the waves. This enables a stable fixing, with at the same time a relative spacing of the fusible conductor away from the fuse housing.

This construction improves the burnout behaviour of the fusible conductor to the extent that it is well enclosed by the quenching means (e.g. quartz sand) in essential regions and in spite of this, optimally cooled by the direct coupling to the cooled housing wall. It is also pre-supposed that this construction, in contrast to that in which the fusible conductor extends in the immediate region of the wall over its entire length, runs less risk of exhibiting prolonged burnout behaviour due to condensation of metallic vapour on the housing. Here, within the scope available the designer must in any case seek compromises and depending on the application of the fuse, provide an optimal means of mounting the fusible conductor.

In one embodiment, detachable fixing means, e.g. threaded fasteners or screws, are provided in the fixing surface for fixing the fuse. The fuse can therefore be removed and separately replaced, independently of other components. This ensures an uncomplicated modular construction.

In one embodiment fixing means are provided on the contacts for coupling to electrical components, e.g. circuit boards, wherein the fixing means are arranged opposite each other and offset with respect to the fixing means that are provided for attaching the fuse, in a direction parallel to the fixing surface. This ensures ease of access when changing the fuse.

In one embodiment the ends of the contacts outside of the fuse housings are essentially parallel to the fixing surface. This facilitates a flat and thereby space-saving construction of the entire complex consisting of fuse, holder and other associated electrical components, such as e.g. circuit boards.

In one embodiment, the contacts on the wall lying opposite the fixing surface push through the fuse housing and where they penetrate through the fuse housing they are essentially perpendicular to the fixing surface. The contacts therefore, without preventing access to the fixing means, can be brought up to the fusing wire. And contacting of the fuse from above—for example by pressing on a printed circuit board with appropriate corresponding diametrically opposed contacts—is possible.

A particular aspect of the invention relates to a fuse arrangement with an electrical fuse as described up to now and with a holder, which holder has a fixing surface and also has at least one coolant channel running through it, wherein the fuse is detachably fixed to the holder via the respective fixing surfaces. The coupling to a liquid-cooled base increases the heat dissipation from the housing wall of the fuse.

Further preferred measures discussed in the present disclosure increase the heat dissipation further.

A particular embodiment of the fuse results from the use of the known direct moulding method for manufacturing the fuse, described above. The fuses produced in such a manner can be produced particularly cheaply. Preferably, it is with this construction specifically that the above described production method with the pre-baked quenching means is used. The mildly volatile solvents or the water used evaporate during or after the moulding process and are absorbed by the plastic used or diffused through this to the outside.

An extension of the invention provides that the housing has a predetermined breaking point and/or pressure relief valves or pressure relief channels, in order to release in a targeted manner any pressure that builds up when the fusible conductor burns out.

The list of reference labels form part of the disclosure. Using the Figures the invention will now be explained in more detail by means of symbols and examples. The Figures will be described in combination and taken as a whole. Equivalent reference labels indicate identical components.

In these:

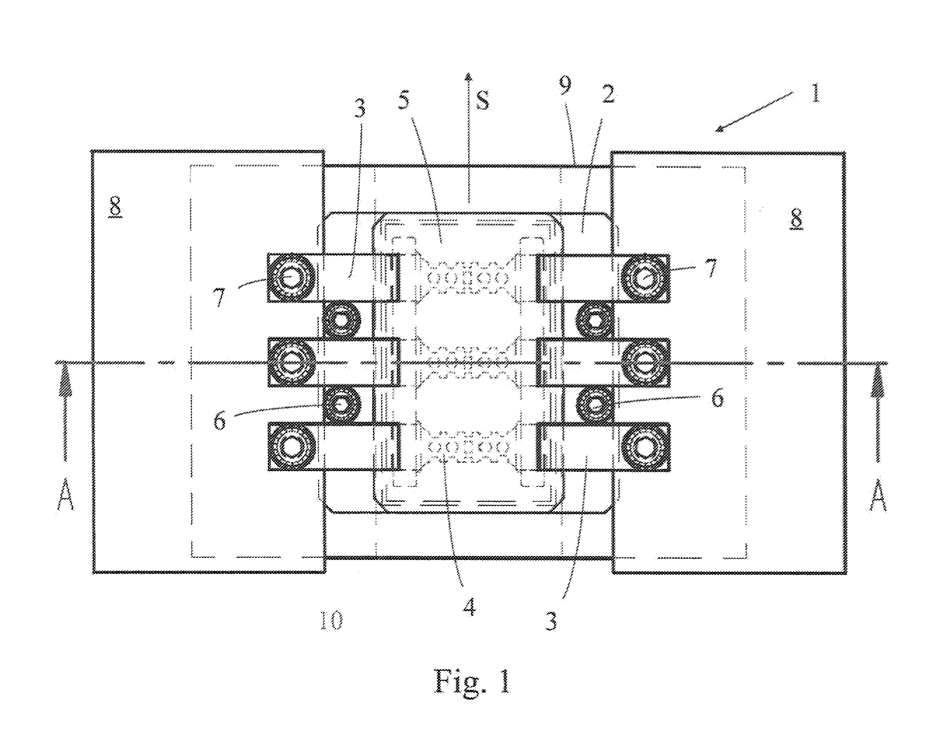

FIG. 1 shows an electrical fuse according to the invention in a fuse arrangement, from above,

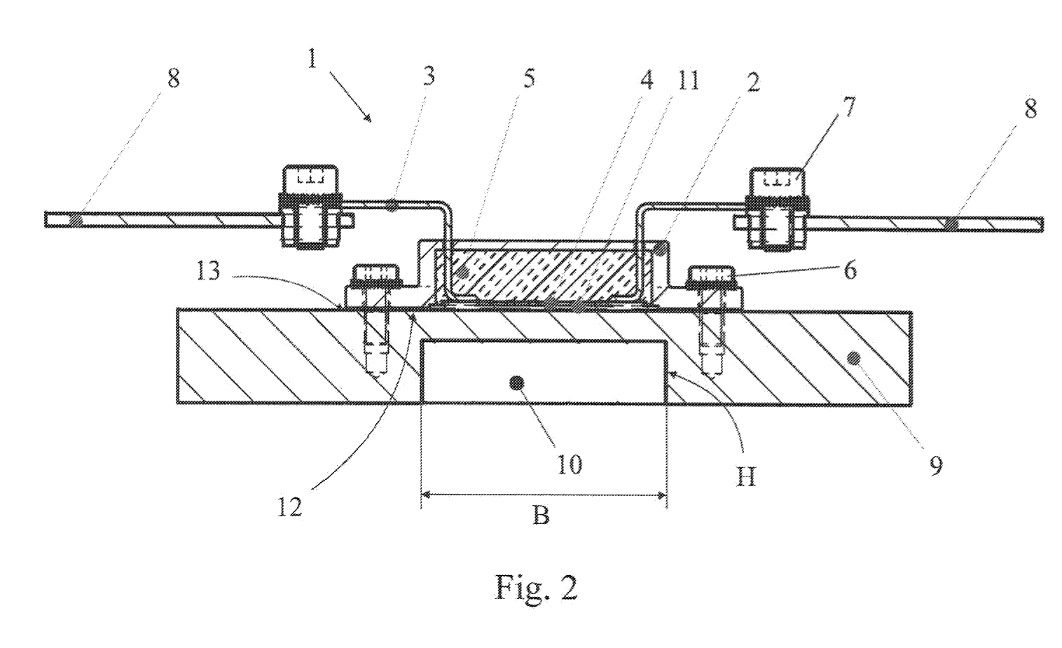

FIG. 2 shows the fuse arrangement of FIG. 1 at section A-A

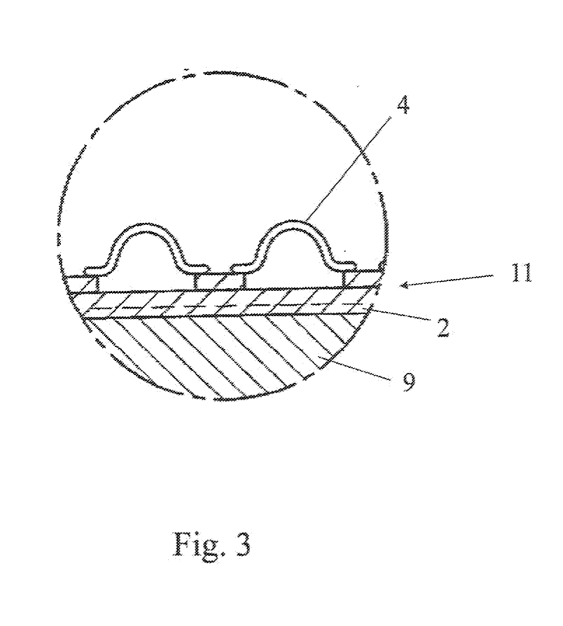

FIG. 3 shows an extract from FIG. 2 with the fusible wire extending along the housing wall,

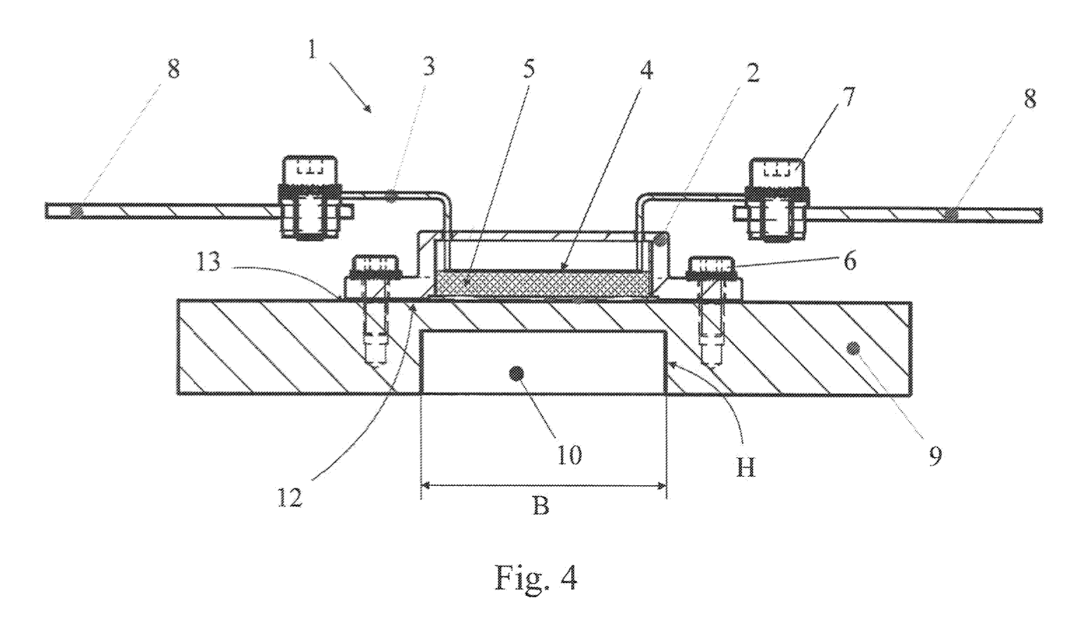

FIG. 4 shows a variant of the fuse arrangement of FIG. 2,

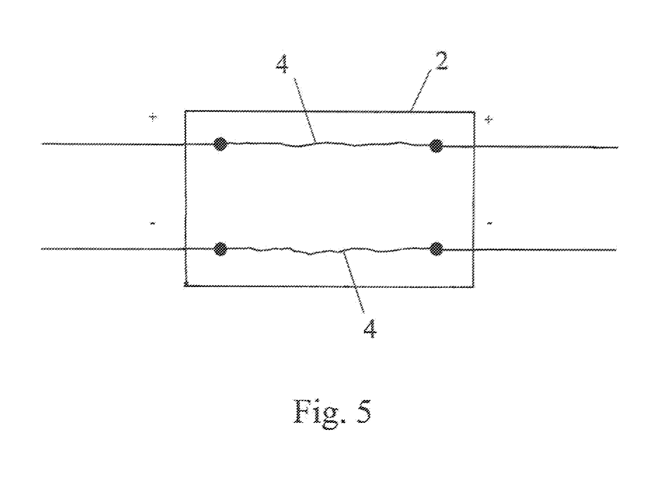

FIG. 5 shows a fuse with two fusible conductors that are independent of each other.

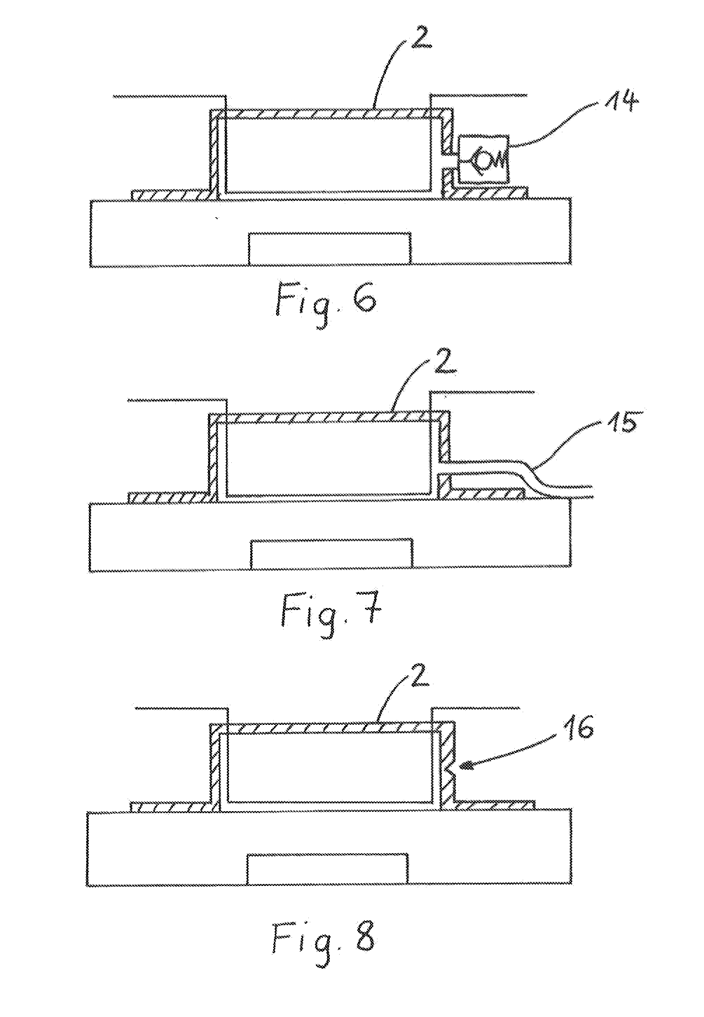

FIG. 6 shows a fuse arrangement having a pressure relief valve.

FIG. 7 shows a fuse arrangement having a pressure relief channel.

FIG. 8 shows a fuse arrangement having a predetermined breaking point.

FIG. 1 shows an electrical fuse 1, which is fixed onto a holder 9. The holder 9 can be a separate cooling platform or a part of a device housing. The electrical contacts 3 projecting out of the fuse housing 2 are coupled with fixing means 7, for example screw connections, to electrical components 8 arranged at the side of the fuse 1. The contacts 3 accessible from outside the fuse housing 2 are connected to each other via a fusible conductor 4, e.g. made of copper or copper alloys, extending inside the fuse housing 2. The fuse housing 2 consists of electrically insulating material, preferably of plastic. The fuse housing 2 is connected to the holder 9 via fixing means 6, e.g. screws or threaded fasteners. A coolant channel 10 passes through the holder 9, the flow direction of which is indicated with the reference label S.

The fixing means 6 for fixing onto the holder 9 and the fixing means 7 for coupling the contacts 3 to other components 9 are shown offset relative to each other in plan view, in order to guarantee ease of access, as is clearly seen in the view of FIG. 1. Due to this, the components 8 can be exchanged separately and independently of one another or the fuse 1, e.g. when it has burnt out, can be detached from the holder 9.

FIG. 2 shows the fuse arrangement of FIG. 1 at section A-A. It can be seen here that the fuse housing 2 has a smooth fixing surface 12, which is formed by a wall of the fuse housing 2. At the side of the fuse body and in continuation of the fixing surface 12, projections in the manner of a flange, in which the fixing means 6 are provided; in the exemplary embodiment illustrated the holes for screws.

The fixing surface 12 is in contact over its whole area with a corresponding fixing surface 13 of the holder 9, which guarantees a connection with good thermal contact. A channel 10 filled with coolant, preferably coolant liquid, such as e.g. water or water/glycol or oil, with the breadth B and height H ensures an efficient dissipation of the heat that is produced in the fuse 1. To allow better thermal dissipation the flow direction S is essentially perpendicular to the fusible conductor 4. The breadth B of the coolant liquid channel 10 essentially corresponds preferably to the length of the fusible conductor 4. Preferably, it is even somewhat larger than the length of the fusible conductor 4. In the exemplary embodiment shown, the coolant channel 10 has a rectangular cross-section, wherein its breadth B is substantially larger than its height H. In this context, the descriptive wording “substantially larger” should be understood to mean that the coolant channel 10 has a flattened cross-section.

The fixing means 6, screws in the exemplary embodiment shown, are anchored in the holder 9 to the side of the coolant channel 10, as shown in FIGS. 1, 2, and 4.

As shown in FIG. 2, the fuse 1 itself comprises a fuse housing 2, which is filled with a compound 5, which includes a powder suitable for quenching arcs, such as, for example, quartz sand. Generally, the arc-quenching material may be a solid material, e.g. sand, a liquid, e.g. isolation-oil, a gel-like material, e.g. silicone-gel, but also a gas, e.g. SF6 (sulphur hexafluoride).

The fusible conductor 4 runs along the base of the fuse housing 2—that is, the housing wall which externally forms the fixing surface 12. The fusible conductor 4 is fixed on this wall at predetermined intervals. The fusible conductor 4 preferably extends in its entire length along the relevant housing wall.

In FIG. 3 an alternative to the fixing 11 of the fusible conductor 4 to the inside of the housing wall is illustrated in more detail. In this case the fusible conductor 4 has a wave-like design and is only fixed to the housing wall in its wave valleys. The fusible conductor preferably comprises a round or flat wire (typically in form of a sheet-strip), which is contacted at defined copper areas by bonding. The copper areas are preferably connected with DCB technology (Direct Copper Bond) to the housing wall, which is typically of plastic or ceramic. This involves a direct connection between copper or a copper alloy and a ceramic holder, the two materials being in direct contact with each other without the use of a solder metal. The fixed connection between the copper and the plastic or ceramic surface is achieved by means of a method in which a molten liquid copper-copper-oxide eutectic is temporarily formed in the boundary region between the copper and the plastic or ceramic surface, which wets the plastic or ceramic surface. The production of DCB substrates is fully described in the prior art. Such a fusible conductor fixing 11 guarantees an optimal heat exchange between the fusible conductor 4 and the housing wall.

Due to the direct coupling to the actively cooled holder 9 via the adjoining fixing surfaces 12, 13, the heat can be dissipated efficiently. The coolant channel 10 in this arrangement is located exactly underneath the fusible conductor 4, or is directly opposite the fusible conductor 4. For better thermal coupling, in the exemplary embodiment of FIG. 1 as shown, multiple (three shown) parallel extending fusible conductors 4 are provided.

In order to facilitate a space-saving, flat construction of the entire complex, the ends of the contacts 3 projecting from the fuse housing 2 are aligned essentially parallel to the fixing surface 12. The penetration of the contacts 3 takes place in the wall of the fuse housing 2 opposite to the fixing surface 12, the contacts 3 extending perpendicular to the fixing surface 12 at the penetration point. Thus the contacts 3 are fed as far as the opposite housing wall, where they are connected to the fusible wire 4. The parallel alignment of the contacts 3 facilitates a simple and easily detachable coupling of electrical components 8, such as for example circuit boards (PCB, Printed Circuit Board), which are therefore also in parallel alignment to the fixing surface 12, which facilitates an optimised flat construction. As an example of a current level that can be tolerated, in the present module 225 A has been reached, wherein other/higher current levels require only appropriate dimensioning, which in the science underlying the invention presents no problems.

The present invention combines the advantage of efficient heat dissipation and uncomplicated exchange of parts due to particularly easy access, in a practical modular construction.

FIG. 4 shows a variant of a fuse 1, in which the fusible conductor 4 is designed to be above the base surface (the wall which forms the fixing surface 12 externally). Lying below this, that is between fusible conductors 4 and base surface, in the known manner sparking sand, fire sand or quenching sand or the like, e.g. quartz sand, is present.

In the versions of FIG. 2 and FIG. 4 the fusible conductors extend essentially in a plane that is parallel to the fixing surface 12. The term “essentially” is to be understood both in the sense that small deviations due to the manufacturing process are also included and that specific geometrical forms of the wire, such as e.g. wave-like shapes, so that wave valleys/peaks can only project slightly out of the relevant plane, are also to be understood as falling under the invention.

Common to all illustrated versions is the flat construction of the fuse housing, wherein the wall, which externally forms the fixing surface (and the wall opposite thereto), has the largest dimensions, while the heights of the side or outer walls are substantially smaller by comparison. Preferably the dimensions, or length, of the wall which externally forms the fixing surface is twice, particularly preferably three times, as large as the height of the side walls.

Put differently, it could also be said that the length of the fusible conductor 4 is substantially larger, preferably twice as large as the height of the side walls.

FIG. 5 shows that multiple fuses are also possible. It should be seen that multiple fusible conductors 4, independent of one another, can also be accommodated in a single fuse housing 2, or are fed through this.

As can be seen from the embodiments the fusible conductor 4 is oriented such, that a straight line connecting the opposing ends of the fusible conductor 4 is essentially parallel to the flat fixing surface 12 of the fuse housing 2. This holds for the fuse of FIG. 4 as well as for the fuse of FIG. 3. Although the fusible conductor 4 of FIG. 3 has a wave-like design, the “global” direction of the current is parallel to the flat fixing surface 12. The “global” direction of the fusible conductor 4 with respect to the flat fixing surface 12 guarantees an optimal (large area) removal of heat produced in the fusible conductor 4.

As already mentioned above the fusible conductor 4 may be made of a flat wire, typically in form of a sheet-strip. Preferably, the flat wire is oriented such, that at least at some points the flat surface of the wire is parallel to the flat fixing surface 12 of the fuse housing 2. For the fusible conductor 4 of FIG. 3 the parallelism is realised in the wave valleys and at the wave peaks of the wave-like design.

In an alternative embodiment the flat wire is designed such, that the flat surface of the wire is in its entire extension parallel to the flat fixing surface 12 of the fuse housing 2. In this case the fusible conductor 4 is not curved but extends within a straight plane.

Both embodiments provide excellent heat removing properties, because one of the flat surfaces of the flat wire faces, at least “globally”, to the flat fixing surface 12. In such a way a large area of the heat generating wire faces directly to the flat fixing surface 12.

Relating to an embodiment of the fuse arrangement with at least one electrical fuse 1 and a holder 9 a particularity lies in the fact, that the fuse arrangement has at least three connections or potentials, respectively: Two current conducting potentials 3, which are connected to each other inside the fuse housing 2, and a third potential of a liquid cooling agent, which may be an electrical conductor, e.g. water. The third potential in form of a cooling fluid is electrically insulated from, but thermally coupled to the two current conducting potentials 3.

FIGS. 6, 7 and 8 shows extensions of the invention. In FIG. 6 the housing 2 has a pressure relief valve 14. In FIG. 7 the housing 2 is connected to a pressure relief channel. In FIG. 8 the housing 2 has a predetermined breaking point. All these means are provided in order to release in a targeted manner any pressure that builds up when the fusible conductor burns out.

### LIST OF REFERENCE LABELS

1—Electrical fuse

2—Fuse housing

3—Electrical contacts

4—Fusible conductor

5—Earth

6—Fixing means

7—Fixing means

8—Electrical component

9—holder

10—Coolant channel

11—Fusible conductor fixing

12—Fixing surface

13—Fixing surface

B—Breadth of the coolant liquid channel

H—Height of the coolant liquid channel

S—Flow direction

What is claimed is:

1-18. (canceled)

19. A fuse mount assembly comprising:
a fuse housing, said fuse housing having a mounting wall, said mounting wall having an external flat fixing surface, said external flat fixing surface adapted to fix said fuse housing in planar contact with a cooled mounting holder, and said mounting wall having an internal surface opposite to said external wall;
said cooled mounting holder having a channel for a heat transfer fluid medium;
a first electrical contact extending out of said fuse housing;
a second electrical contact extending out of said fuse housing;
a fusible conductor extending inside said fuse housing, said fusible conductor electrically connecting said first electrical contact to said second electrical contact;
said fusible conductor having at least one sheet strip, said at least one sheet strip having side edges, said at least one sheet strip having an upper face, said at least one sheet strip having a lower face; and,
said lower face of said at least one sheet strip facing said internal surface of said mounting wall.

20. A fuse mount assembly as claimed in claim 19, further comprising:
a plurality of detachable fasteners fixing said fuse housing to said cooled mounting holder.

21. A fuse mount assembly as claimed in claim 20, further comprising:
a first fuse housing flange, said first flange disposed at a first side of said fuse housing;
a second fuse housing flange, said second flange disposed at a second side of said fuse housing; and,
said plurality of detachable fasteners passing through said flanges.

22. The fuse mount assembly as claimed in claim 21, wherein:
said plurality of detachable fasteners are respectively anchored in said cooled mounting holder.

23. The fuse mount assembly as claimed in claim 19, wherein:
the breadth dimension of said channel is larger than the length of said fusible conductor.

24. A fuse mount assembly as claimed in claim 19, further comprising:
a fuse housing cavity in the vicinity of said fusible conductor, said fuse housing cavity being at least partially filled with a spark quenching medium.

25. The fuse mount assembly as claimed in claim 24, wherein:
said spark quenching medium is selected from the group consisting of sand and gel.

26. The fuse mount assembly as claimed in claim 19, wherein:
said sheet strip extends parallel to said internal surface of said mounting wall.

27. The fuse mount assembly as claimed in claim 19, wherein:
said fusible conductor extends along a length of said internal surface of said mounting wall and has a wavelike profile, said fusible conductor being secured to said internal surface of said mounting wall at troughs of the wavelike profile.

28. A fuse mount assembly as claimed in claim 27, further comprising:
a plurality of ceramic holders each respectively disposed on said fuse housing mounting wall internal surface, each at a respective location corresponding to a respective trough of said fusible conductor's wavelike profile, said fusible conductor being connected at troughs of its wavelike profile to said ceramic holders.

29. The fuse mount assembly as claimed in claim 19, wherein:
said first electrical contact extends out of said fuse housing in a direction perpendicular to said external flat fixing surface; and,
said second electrical contact extends out of said fuse housing in a direction perpendicular to said external flat fixing surface.

30. A fuse mount assembly as claimed in claim 19, further comprising:
a fuse housing side wall connected to said mounting wall, said fuse housing side wall having a height dimension value that is less than one-half of a major-dimension value of said fuse mounting wall external flat fixing surface.

31. A fuse mount assembly comprising:
a fuse housing, said fuse housing having a mounting wall, said mounting wall having an external flat fixing surface, said external flat fixing surface adapted to fix said fuse housing in planar contact with a cooled mounting holder, and said mounting wall having an internal surface opposite to said external wall;
said cooled mounting holder having a channel for a heat transfer fluid medium;
a plurality of fusible conductors extending inside said fuse housing, each of said plurality of fusible conductors having at least one respective sheet strip, each respective sheet strip having respective side edges, each respective sheet strip having a respective upper face, and each respective sheet strip having a respective lower face;
said plurality of respective lower faces of said plurality of respective sheet strips each facing said internal surface of said mounting wall;
each respective one of said plurality of fusible conductors being connected to a respective first electrical contact that extends out of said fuse housing; and,
each respective one of said plurality of fusible conductors being connected to a respective second electrical contact that extends out of said fuse housing.

32. A fuse mount assembly as claimed in claim 31, further comprising:
a plurality of detachable fasteners fixing said fuse housing to said cooled mounting holder.

33. A fuse mount assembly as claimed in claim 32, further comprising:
a first fuse housing flange, said first flange disposed at a first side of said fuse housing;
a second fuse housing flange, said second flange disposed at a second side of said fuse housing; and,
said plurality of detachable fasteners passing through said flanges.

34. The fuse mount assembly as claimed in claim 33, wherein:
said plurality of detachable fasteners are respectively anchored in said cooled mounting holder outside of said channel.

35. A fuse mount assembly comprising:
a fuse housing, said fuse housing having a mounting wall, said mounting wall having an external flat fixing surface, said external flat fixing surface adapted to fix said fuse housing in planar contact with a cooled mounting holder, and said mounting wall having an internal surface opposite to said external wall;
a first fuse housing flange, said first flange externally disposed at a first side of said fuse housing;
a second fuse housing flange, said second flange externally disposed at a second side of said fuse housing;
a plurality of detachable fasteners fixing said first and second fuse housing flanges to said cooled mounting holder in arrangement wherein the fasteners passing through said first flange are aligned opposite to the fasteners passing through said second flange;
said cooled mounting holder having a channel for a heat transfer fluid medium;
a plurality of fusible conductors extending inside said fuse housing, each of said plurality of fusible conductors having at least one respective sheet strip, each respective sheet strip having respective side edges, each respective sheet strip having a respective upper face, and each respective sheet strip having a respective lower face;
said plurality of respective lower faces of said plurality of respective sheet strips each facing said internal surface of said mounting wall;
each respective one of said plurality of fusible conductors being connected to a respective first electrical contact that extends out of said fuse housing;
a first plurality of contact fasteners each respectively associated with a respective one of said plurality of first electrical contacts to respectively connect said respective ones of said plurality of first electrical contacts to respective electrical conductors;
each respective one of said plurality of fusible conductors being connected to a respective second electrical contact that extends out of said fuse housing;
a second plurality of contact fasteners each respectively associated with a respective one of said plurality of second electrical contacts to respectively connect said respective ones of said plurality of second electrical contacts to respective electrical conductors, said second plurality of contact fasteners being aligned opposite to said first plurality of contact fasteners across said fuse housing, the alignment of said second and first pluralities of contact fasteners being offset relative to said alignment of said plurality of detachable fasteners passing through said first and second flanges.

36. The fuse mount assembly as claimed in claim 35, wherein:
said plurality of detachable fasteners are respectively anchored in said cooled mounting holder outside of said channel.

37. The fuse mount assembly as claimed in claim 35, wherein:
the breadth dimension of said channel is larger than the respective lengths of said plurality of fusible conductors.

38. A fuse comprising:
a fuse housing, said fuse housing having a mounting wall, said mounting wall having an external flat fixing surface, said external flat fixing surface adapted to fix said fuse housing in planar contact with fuse supports, and said mounting wall having an internal surface opposite to said external wall;
a fuse housing side wall connected to said mounting wall, said fuse housing side wall having a height dimension value that is less than one-half of a major-dimension value of said fuse mounting wall external flat fixing surface;
a first electrical contact extending out of said fuse housing in a direction perpendicular to said external flat fixing surface;
a second electrical contact extending out of said fuse housing in a direction perpendicular to said external flat fixing surface;
a fusible conductor extending inside said fuse housing, said fusible conductor electrically connecting said first electrical contact to said second electrical contact;
said fusible conductor having at least one sheet strip, said at least one sheet strip having side edges, said at least one sheet strip having an upper face, said at least one sheet strip having a lower face; and,
said lower face of said at least one sheet strip facing said internal surface of said mounting wall.
